(19) United States
(12) Patent Application Publication
(10) Pub. No.: US 2026/0194410 A1
(43) Pub. Date: Jul. 9, 2026

(54) IN-VEHICLE GAS LEAK DETECTION SAFETY AND ALARMING SYSTEM

(71) Applicant: SAUDI ARABIAN OIL COMPANY, Dhahran (SA)

(72) Inventors: Tariq ALATEEQ, Dhahran (SA); Fahad AL-AMER, Dhahran (SA); Turki ALANEZI, Dhahran (SA)

(73) Assignee: SAUDI ARABIAN OIL COMPANY, Dhahran (SA)

(21) Appl. No.: 19/010,638

(22) Filed: Jan. 6, 2025

(51) Int. Cl. G01M 3/04; B60R 16/03; F02N 11/08; F02N 11/10; G08B 17/117

(52) U.S. Cl. CPC G01M 3/04; B60R 16/03; F02N 11/087; F02N 11/101; G08B 17/117

(57) ABSTRACT

A gas leak detection system includes a plant subsystem including a gas leak detection sensor disposed at an industrial facility and at least one vehicle subsystem including a vehicle operable in and around the industrial facility. The vehicle subsystem further includes at least one vehicle gas leak detection sensors carried by the vehicle and operable to detect the presence and concentration of gasses in the atmosphere in and around the vehicle, a controller carried by the vehicle and operably coupled to the at least one vehicle gas leak detection sensor to identify a gas leak and a communication device carried by the vehicle and communicatively coupled to the controller and the plant subsystem. The communication device is operable to transmit a alarm signal to the plant subsystem in response to the controller identifying a gas leak and to receive an alarm signal from the plant subsystem.

### FIELD OF THE DISCLOSURE

The present disclosure relates generally to monitoring safety conditions of industrial facilities, and more particularly to systems and methods for alerting the occupants of vehicles operating in and around the facilities to environmental dangers such as gas leaks from the facilities.

### BACKGROUND OF THE DISCLOSURE

Industrial facilities such as oil refineries, central tank batteries, natural gas plants and hydrocarbon wellbore sites have equipment for the transport and processing of combustible and/or poisonous fluids. For example, petrochemical facilities can produce gases such as Butane, Propane, Methane, Hydrogen, Carbon Monoxide and H2S, which are often invisible to the human eye, but can be toxic, flammable or otherwise hazardous to the health and safety of personnel in and around the petrochemical facilities. Most facilities employ a variety of leak detection systems including stationary gas sensors, ultrasonic leak detectors and perimeter monitoring sensors that measure the concentration of a chemical in the air at the perimeter of the facility. If an anomaly is detected by the leak detection systems, an audio and/or visual alarm may be activated to alert nearby personnel to the potential danger.

The ability for these leak detection systems to alert personnel traveling in vehicles in and around the facilities, however, may be limited. Frac trucks, well-testing vehicles and even firefighting vehicles deployed to remedy a gas leak may encounter and present various dangers at industrial facilities. In many instances, an occupant of a vehicle traveling into a dangerous environment may not be alerted to the danger until exiting the vehicle. Additionally, the vehicles themselves may present a danger by generating sparks that could ignite a flammable gas that has leaked from the facility.

Accordingly, a leak detection system that effectively protects personnel from the specific dangers of vehicles traveling in and around the facilities may help to improve the safety of these industrial facilities.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a gas leak detection system can include a plant subsystem with a plant gas leak detection sensor disposed at a stationary location at an industrial facility. The plant gas leak detection sensor can be operable to detect the presence and concentration of gasses in the atmosphere in and around the industrial facility. The gas leak detection system can further include a vehicle subsystem mounted to a vehicle operable in and around the industrial facility. The at least one vehicle subsystem can include a vehicle gas leak detection sensor carried by the vehicle and operable to detect a presence and a concentration of gasses in the atmosphere in and around the vehicle, a controller carried by the vehicle in communication with the vehicle gas leak detection sensor to identify a gas leak based on the detection of the presence and concentration of the gasses and a communication device carried by the vehicle and in communication with the controller and the plant subsystem. The communication device can be operable to transmit a vehicle alarm signal to the plant subsystem in response to the controller identifying the gas leak and to receive a plant alarm signal from the plant subsystem.

According to another example embodiment consistent with the present disclosure, a method for operating a gas leak detection system includes (a) detecting the presence and concentration of a gas in the atmosphere with a gas leak detection sensor, (b) identifying a gas leak at with a controller based on the concentration of the gas detected, (c) communicating an alarm signal between a plant subsystem disposed at an industrial facility and a vehicle subsystem in response to identifying the gas leak, wherein the vehicle subsystem is mounted to a vehicle operable in and around the industrial facility and (d) activating a siren of the vehicle subsystem in response to identifying the gas leak.

According to still another example embodiment consistent with the present disclosure, a vehicle gas leak detection sensors carried by a vehicle operable in and around an industrial facility, at least one the vehicle and operable to detect the presence and concentration of gasses in the atmosphere in and around the vehicle and a controller carried by the vehicle and in communication with the vehicle gas leak detection sensor to identify a gas leak based on the concentration of the gas detected. The gas leak detection apparatus can further include a wind sensor in communication with the controller and operable to detect a direction and a speed of the wind around the vehicle, and also can include a communication device carried by the vehicle and in communication with the controller. The communication device can be operable to transmit a vehicle alarm signal to a plant subsystem of the industrial facility in response to the controller identifying a gas leak and to receive a plant alarm signal from the plant subsystem.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of a leak detection system including a stationary subsystem at an industrial facility and a plurality of mobile subsystems carried by a fleet of vehicles in accordance with one or more aspects of the present disclosure.

FIG. 2 is a schematic view of one of the mobile subsystems of FIG. 1 illustrating a controller operatively coupled to an ignition system of the vehicle in accordance with one or more aspects of the present disclosure.

FIG. 3A is a schematic view of a starter relay shut-down circuit of the ignition system in accordance with one or more aspects of the present disclosure.

FIG. 3B is a schematic view of an ignition coil shut-down circuit of the ignition system in accordance with one or more aspects of the present disclosure.

FIG. 4 is a schematic view of an alarm activation circuit of the mobile subsystem in accordance with one or more aspects of the present disclosure.

FIG. 5 is a flowchart illustrating a procedure for operating the leak detection system of FIG. 1 in accordance with one or more aspects of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to systems and methods for detecting gas leaks and other hazardous conditions in and around an industrial facility. The systems described herein may include a plant subsystem located at a stationary location within the industrial facility and at least one mobile vehicle subsystem carried by a vehicle operating in and around the industrial facility. The vehicle subsystem may include a communication device, a gas leak detector, an alarm and a wind sensor all communicatively coupled to a controller. The controller is operable to receive a signal from either the communication device or the gas leak detector that indicates a dangerous condition has been identified and to determine an appropriate response. For example, the controller may activate the alarm or provide instructions to guide an operator of the vehicle to a safe destination based on the location of the dangerous condition identified and a wind direction detected by the wind sensor. In some embodiments, the controller may disable the vehicle to prevent sparking if the gas leak detector has detected a flammable gas in the environment. The communication device may communicate with the plant subsystem and other vehicle subsystems through a blockchain or another verification system to ensure the signals are received from a trusted party.

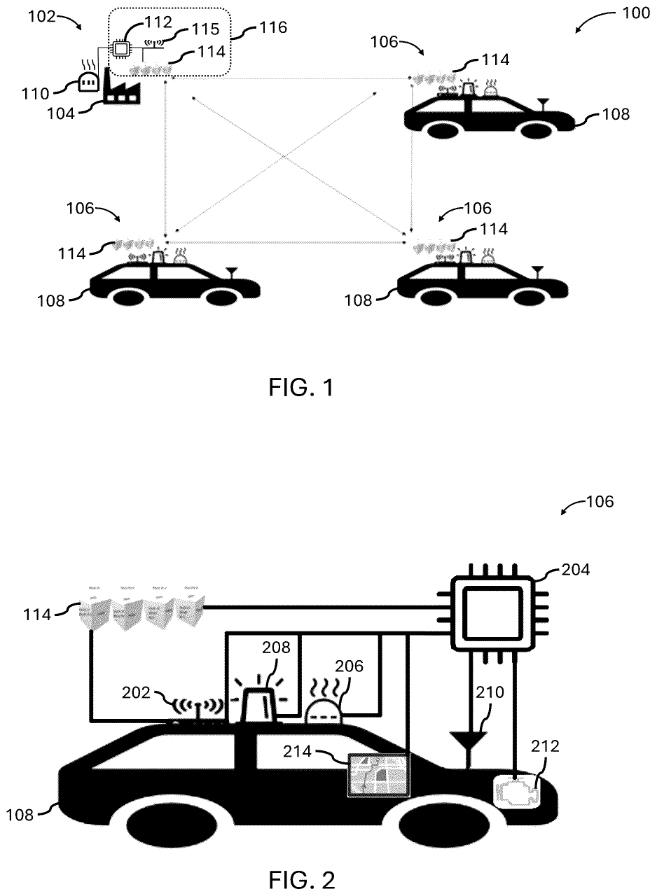

FIG. 1 is a schematic view of a gas leak detection system 100, which includes a plant subsystem 102 located at a stationary location within an industrial facility 104 and at least one mobile vehicle subsystem 106 carried by a vehicle 108. The industrial facility 104 may include a petrochemical refinery, a fuel storage tank farm, a collection of oil and gas wellbores or rigs spread over a large area or other facilities where gas leaks are possible. The plant subsystem 102 may include one or more plant gas leak detection sensors 110 operable to detect a presence and a concentration of gasses in and around the industrial facility. The gas leak detection sensors 110 may transmit a signal indicative of the gas leak to a controller 112 and the controller 112 may detect the gas leak from the signal transmitted from the plant gas leak detection sensor 110. For example, the controller 112 may identify a gas leak by comparing the concentration of the gasses detected to one or more predetermined thresholds and determining that a gas leak has occurred when the concentration is above the predetermined thresholds. The controller may be operable to identify the type of the gasses detected and assess a severity of the threat posed by leaking gasses detected. For example, the controller 112 may determine whether the gas leaking is flammable or non-flammable. The controller 112 may then activate an appropriate alarm or alert to warn personnel at the industrial facility 104 of the danger presented by the gas leak.

The vehicle 108 of each of the vehicle subsystems 106 may be one of a fleet of vehicles 108 operating in and around the industrial facility 104. In the illustrated embodiment, three vehicles 108 are illustrated, but more or fewer vehicles 108 may be provided without departing from the scope of the disclosure. Also, the vehicles 108 are illustrated as passenger cars, but in other embodiments, other types of vehicles including trucks, locomotives, drones, etc. may carry one of the mobile subsystems 106 without departing from the scope of the disclosure.

The plant subsystem 102 is communicatively coupled to each of the vehicle subsystems 106 and each vehicle subsystem 106 is communicatively coupled to each of the other vehicle subsystems 106. The plant subsystem 102 and each of the vehicle subsystems 106 include a communication gateway 114, which is operable to encrypt and verify communications sent and received between the subsystems 102, 106. The communication gateway 114 may include a blockchain ledger or similar verification system as appreciated by those skilled in the art. The communication gateway 114 ensures that any communication received by the subsystems 102, 106 is from a trusted party. As described in greater detail below, if a gas leak is detected by any of the subsystems 102, 106, an appropriate signal may be transmitted to the remaining subsystems 102, 106 such that an appropriate action may be undertaken. In some embodiments, the controller 112, the communication gateway 114 and a communication device 115 may be installed to an existing alarm system as part of an adapter 116 to adapt the existing alarm system to the plant subsystem 102 of the present disclosure. The adapter 116 allows the plant subsystem 102 to communicate with the vehicle subsystems 106 by providing communication protocols conversions and providing the blockchain ledger if necessary.

Referring to FIG. 2, one of the vehicle subsystems 106 is illustrated schematically in greater detail. The vehicle subsystem 106 includes a communication device 202 carried by (or operatively coupled to) the vehicle 108. In some embodiments, the communication device 202 may include a portable electronic device including a transceiver for transmitting and receiving signals over a short-range or long-range communications network. For example, in some embodiments, the communication device 202 may transmit and receive radio frequency signals, sonar, radar or any other types of wireless signals recognized in the art. In some embodiments, wireless technologies such as Bluetooth, NearLink, and ultra-wideband (UWB) may be employed by the communication device 202. In other embodiments, the communication device 202 may also communicate over long range networks such as LORA, HaLo, Wi-Fi, LEO satellites and cellular networks, e.g., 3G, 4G, 5G, 6G, etc. The communication device 202 is operably coupled to the communication gateway 114 such that the vehicle subsystem 106 may securely communicate with the plant subsystem 102 (FIG. 1) and other vehicle subsystems 106.

The communication device 202 and/or the communication gateway is operably coupled to a controller 204 carried by the vehicle 108. The controller 204 may receive signals from the communication device and determine an appropriate response. In some embodiments, the controller 154 may be a computer-based system that may include a processor, a memory storage device, and programs and instructions, accessible to the processor for executing the instructions utilizing the data stored in the memory storage device. In other embodiments, the controller 154 may include manual controls that may be manipulated by an operator to control any of the procedures and equipment described herein. The controller 204 may additionally be communicably coupled to at least one vehicle gas leak detection sensor 206, a siren 208, and a wind sensor 210 carried by the vehicle 108, as well as an ignition system 212 and an on-board computer system 214 of the vehicle 108.

The vehicle gas leak detection sensor 206 may be operable to detect gas leak data such as the presence, type and concentration of gasses including, e.g., Butane, Propane, Methane, Hydrogen, Carbon Monoxide and H2S in the atmosphere (environment) around the vehicle 108. In the vehicle subsystem 106, the vehicle gas leak detection sensor 206 is shown arranged on the roof of the vehicle 108. In other embodiments, one or more vehicle gas leak detection sensors 206 may alternatively or additionally be positioned on an underside of the vehicle 108, e.g., for more accurate detection of heavier-than-air gasses, and/or within an interior passenger cabin of the vehicle, e.g., to determine the extent to which a leaking gas may have penetrated the passenger cabin. The vehicle gas leak detection sensor 206 may transmit an appropriate signal to the controller 204 indicative of the specific type of gas detected and a concentration of the gas detected. The controller 204 may identify a gas leak by comparing the concentration of the gas detected to an appropriate threshold and may determine an appropriate response based at least in part on the concentration and type of gas detected.

The wind sensor 210 may be operable to detect the direction and a speed of the wind around the vehicle 108. The wind sensor 210 may include, for example, one or more of a pitot tube wind speed sensor that detects a pressure difference between wind detected from perpendicular directions, a rotating wind speed sensor that measures a speed of a rotating cup or propeller, an ultrasonic anemometer that emits and receives ultrasonic waves that are affected by the wind and/or a hot-wire wind speed sensor that heats a wire with an electric current and measures a temperature of the wire when the wire has been cooled by the wind.

The wind sensor 210 may transmit a signal indicative of the wind data (including the wind speed and direction) to the controller 204, which may store the wind data along with a time stamp and location of the vehicle 108 at the time the wind data was collected. The processor 204 may correlate the wind data with gas leak data collected by the vehicle gas leak sensor 206. The wind data and gas leak data may be stored by controller 204 and/or transmitted through the communication gateway 114 to plant subsystem 102 and the other vehicle subsystems 106. A ledger (not shown) of the communication gateway 114 may store the wind data and gas leak data for analytics to be performed at a future time.

The controller 204 may determine an appropriate response to the gas leak data and the wind data collected. For example, the controller 204 may compare the type of gas detected to a predetermined list of combustible gasses, and if the gas detected is on the list of combustible gasses, the controller 204 may compare the concentration of the gas detected to a predetermined threshold for the combustible gas detected. If the concentration is greater than the predetermined threshold, the controller 204 may transmit an appropriate signal, e.g., an electrical or electronic instruction signal, to the ignition system 212 and/or the on-board computer system 214 to disable the vehicle 108 as described in greater detail below. The controller 204 may additionally transmit an appropriate signal to the siren 208 to cause the siren to 208 to transmit visual and/or audible alarm to nearby personnel.

In some embodiments, the controller 204 may determine that a non-combustible gas has been detected and may further determine a route to a safe location. The controller 204 may determine the route based at least partially on the gas leak data and wind data collected by the vehicle subsystem 106 and/or transmitted to the vehicle subsystem 106 from the plant subsystem 102 (FIG. 1) and/or another vehicle subsystem 106. For example, the route may avoid any location in which the wind may be predicted to spread the gas leak. Once the communication gateway 114 verifies that communications received by the communication device 202 originated from a trusted or nearby source, the controller 204 may transmit instructions to the on-board computer system 214 to cause the on-board communication system of the vehicle 108 to cause the on-board computer system 214 to display directions to the safe location on a heads-up display of the computer system 214.

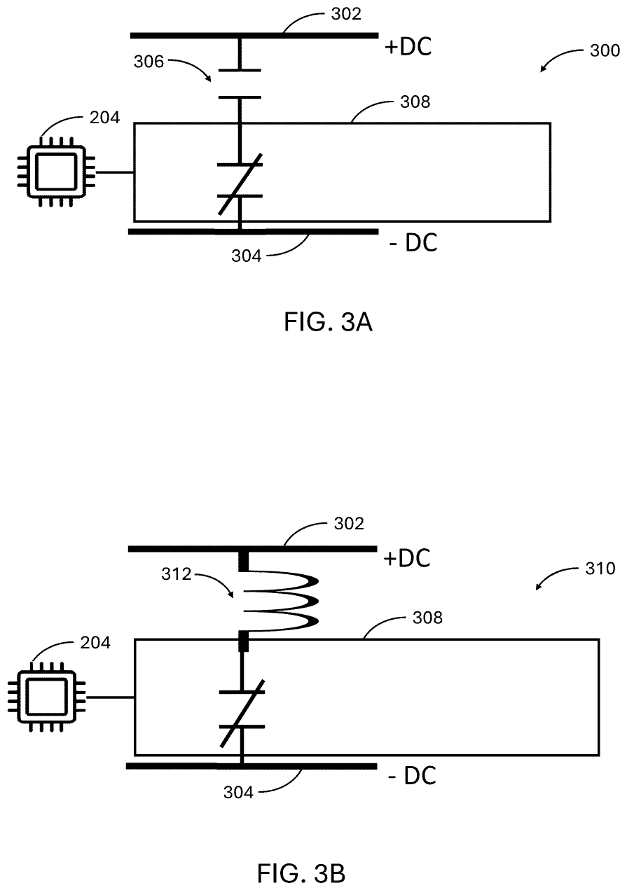

Referring to FIG. 3A, a schematic view of a starter relay shut-down circuit 300 of the ignition system 212 (FIG. 2) in accordance with one or more aspects of the present disclosure. The starter relay shut-down circuit 300 is generally disposed between positive and negative terminals 302, 304 of a battery of the vehicle 108 (FIG. 2). The starter relay shut-down circuit 300 includes a starter relay 306, which may be operably coupled to an ignition switch (not shown) and a starter motor (not shown) of the vehicle 108 (FIG. 1). The starter relay 306 may be operable to receive a low-power signal from the ignition switch to engage the starter motor. The starter relay shut-down circuit 300 also includes a control relay 308 operably coupled to starter relay 306 and the controller 204. The control relay 308 may be normally closed such that the starter relay 306 may engage the starter motor when no gas leak has been detected. In some embodiments, the control relay 308 may remain closed when a non-flammable gas leak is detected. When the control relay 308 receives an appropriate signal (e.g., current) from the controller 204 indicating that a combustible gas leak has been detected, the control relay 308 may open, and thereby prevent the starter relay 306 from receiving the low-power signal from the ignition switch. In this manner, the control relay 308 may prevent the vehicle 108 from starting only when a flammable gas leak is detected. When a non-flammable gas leak is identified, the vehicle 108 may remain operational such that the vehicle may move to a safe location.

Referring to FIG. 3B, a schematic view of an ignition coil shut-down circuit 310 of the ignition system 212 (FIG. 2) in accordance with one or more aspects of the present disclosure. Similar to the starter relay shut-down circuit 300 (FIG. 3A), the ignition coil shut-down circuit 310 is generally disposed between the positive and negative terminals 302, 304 of the battery. The ignition coil shut-down circuit 310 includes an ignition coil 312, which may be operably coupled to an ignition switch (not shown) and one or more spark plugs (not shown) of the vehicle 108 (FIG. 1). The ignition coil 312 may be operable to receive a low-voltage current from the battery when the ignition switch is turned on, and to transform the low-voltage current into a high voltage current through electromagnetic induction. The high voltage current may be provided to the spark plugs to create sparks.

The ignition coil shut-down circuit 310 also includes the control relay 308 operably coupled to the ignition coil 312 and the controller 204. As described above, the control relay 308 may be normally closed. Thus, when no gas leak is detected, the ignition coil 123 may operate as described above to provide the high voltage to the spark plugs. When a gas leak is detected, the controller 204 may provide an appropriate signal to the control relay 308 to cause the control relay to open, and thereby prevent the ignition coil 312 from receiving the low voltage current. The ignition coil 312 may thus be prevented from providing a high-voltage current to the spark plugs, and in this manner the control relay 308 may prevent the vehicle 108 from starting when the controller 204 determines that a gas leak has been detected.

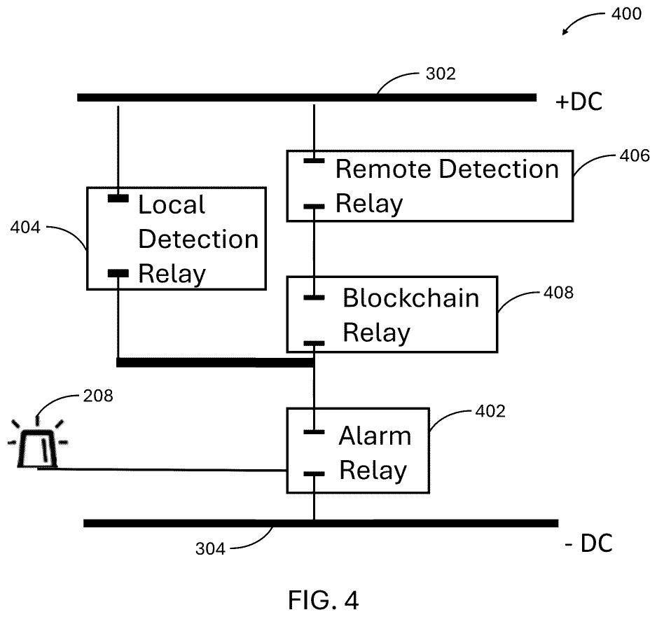

Referring now to FIG. 4, a schematic view of an alarm activation circuit 400 of the mobile subsystem 106 in accordance with one or more aspects of the present disclosure. The alarm activation circuit 400 may be incorporated into the controller 112 (FIG. 1) or the controller 204 (FIG. 2), or may be operably coupled to the controller 112, 204 of the subsystem 102, 106. The alarm activation circuit 400 includes an alarm relay 402 coupled between the positive and negative terminals 302, 304 and operably coupled to the siren 208. The alarm relay 402 may be normally open such that the siren 208 will not be activated until and unless the alarm activation circuit 400 determines that a legitimate need exists to activate the siren 208.

The alarm activation circuit 400 may determine that the need exists in at least one of two ways. First, the alarm activation circuit 400 includes a local detection relay 404, which may be activated when a gas leak is detected by the mobile subsystem 106 that includes the alarm activation circuit 400. The local detection relay 404 may be normally open and may be operably coupled to the vehicle gas leak sensor 206 such that the local detection relay 404 may be closed in response to the detection of a gas leak. When the local detection relay 404 is closed, the alarm relay 402 may be immediately energized and the siren 208 may be activated. Additionally in some embodiments, when the alarm relay 402 is closed, the communication device 202(FIG. 2) may be activated to transmit an appropriate notification of the gas leak to the plant subsystem 102 (FIG. 1) and other vehicle subsystems 106.

Next, the alarm activation circuit 400 includes a remote detection relay 406 and a blockchain relay 408, which may be activated when a gas leak is detected by the plant subsystem 102 or by another mobile subsystem 106 remote from the alarm activation circuit 400. The remote detection relay 406 and the blockchain relay 408 are arranged in series with one another and together in parallel with the local detection relay 404. The remote detection relay 406 may be normally open and may be operably coupled to the communication device 202 (FIG. 2) such that the remote detection relay 406 may be closed in response to receiving a communication that a gas leak was detected by the plant subsystem 102 or by another mobile subsystem 106. Similarly, the blockchain relay 408 may be normally open and may be coupled to the communication gateway 114 such that the blockchain relay 408 may be closed when the communication gateway 114 verifies that the communication (e.g., a received alarm signal such as a plant alarm signal or a vehicle alarm signal) received from the other subsystem 102, 106 is legitimately received from a trusted source. When the remote detection relay 406 and the blockchain relay 408 are both closed, the alarm relay 402 may be immediately energized and the siren 208 may be activated.

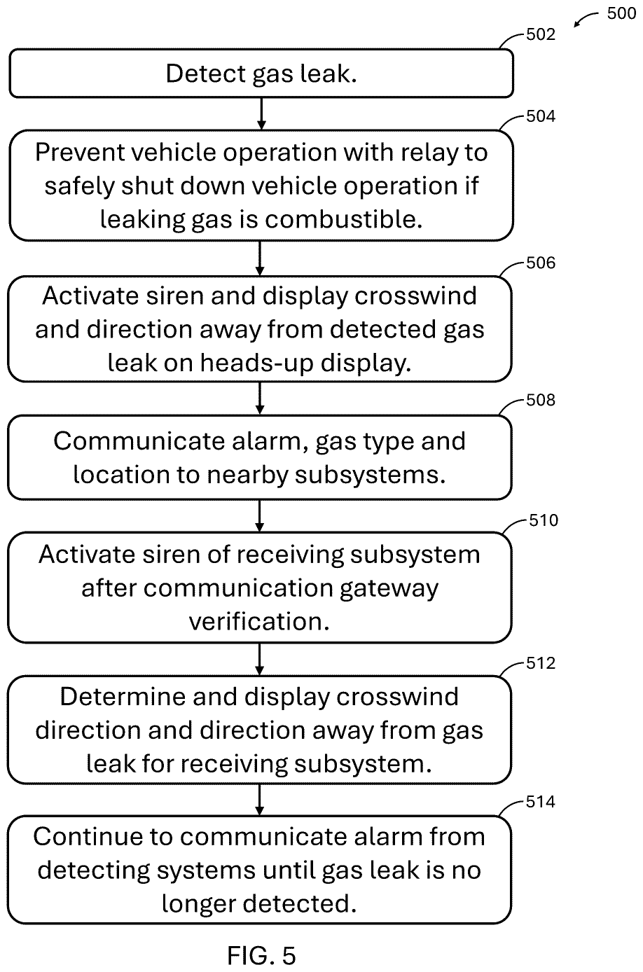

Referring now to FIG. 5, and with continued reference to FIGS. 1-4, an example procedure 500 is illustrated for implementing the gas leak detection system 100. Initially at step 502, a gas leak is detected. One or more of the plant gas leak detection sensors 110 of the plant subsystem 102 and the vehicle gas leak detection sensors 206 of the vehicle subsystems 106 may detect a type and concentration of gas in the atmosphere. An appropriate signal indicative of the type and concentration may be transmitted to the controller 112, 204 of the detecting subsystem 102, 106, and the controller 112, 204 may compare the concentration to predetermined thresholds for the particular gas type to determine whether a gas leak has occurred. The controller 112, 114 may also determine whether the leaking gas detected is combustible.

Next at step 504, if the detecting subsystem is a vehicle subsystem 106 and the leaking gas detected is combustible, operation of the vehicle 108 may be safely discontinued. For example, the controller 204 may open the control relay 308 to disable the starter relay 306 and/or the ignition coil 312 to prevent further operation of the vehicle 108. In some embodiments, the controller 204 may additionally operate the vehicle 108 to close the windows and unlock the doors of the vehicle 108 to ensure the occupants of the vehicle 108 may promptly exit the vehicle 108 if necessary. The controller 204 may also determine whether the leaking gas is combustible or non-combustible, and may determine appropriate directions to safety, e.g., walking directions or driving directions. At step 506, the siren 208 may be activated, e.g., by closing the local detection relay 404 and instructions and information for avoiding the gas leak may be displayed on a heads-up display. For example, a heads-up display of an on-board computer system 214 of the vehicle 108 may be employed to display the information and instructions. The information and instructions may include a direction of the crosswind detected by the wind sensor 210 and/or directions for reaching a safe location avoiding the gas leak. The directions may include driving directions if the gas leak detected is a non-combustible gas and may include walking directions if the gas leak detected is combustible and the vehicle 108 has been shut down.

At step 508, an appropriate signal indicative of the alarm (gas type, concentration, location, time etc.) may be communicated through the communication device 202 to nearby subsystems 102, 106. At step 510, the communication gateway 114 at the receiving subsystem 102, 106 may verify the source and validity of the signal received and activate a siren 208 at the receiving subsystem. For example, the controller 112, 204 at the receiving subsystem 106 may close the remote detection relay 406 and the blockchain relay 408 to thereby activate the alarm relay 402 and the siren 208.

Next at step 512, the controller 112, 204 may determine a crosswind direction and direction away from the gas leak based on the signal received and on information generated by the detecting subsystem 102, 106. For example, the plant gas leak detection sensors 110, vehicle gas leak detection sensor 206 and/or the wind sensor 210 may provide information to the controller 112, 204 at the receiving subsystem from which the controller 112, 204 may determine whether the gas leak is present in the local environment or approaching the local environment. The local cross wind direction and direction may be displayed on a heads-up display of the receiving subsystem 102, 106. In some embodiments, if the controller 204 of a receiving vehicle subsystem determines that it is appropriate, the vehicle 108 of the receiving subsystem 106 may be shut down.

At step 514, the detecting subsystem 102, 106 may continue to communicate the alarm until the gas leak is no longer detected. When the gas leak is no longer detected, the control relays 308 may return to their normally closed configuration and the relays 402, 404, 406, 408 of the alarm circuit 400 may return to their normally open configuration. The sirens 208 may thereby be deactivated and the operation of the vehicles 108 may be resumed.

Embodiments disclosed herein include:
A. A gas leak detection system can include a plant subsystem with a plant gas leak detection sensor disposed at a stationary location at an industrial facility. The plant gas leak detection sensor can be operable to detect the presence and concentration of gasses in the atmosphere in and around the industrial facility. The gas leak detection system can further include a vehicle subsystem mounted to a vehicle operable in and around the industrial facility. The at least one vehicle subsystem can include a vehicle gas leak detection sensor carried by the vehicle and operable to detect a presence and a concentration of gasses in the atmosphere in and around the vehicle, a controller carried by the vehicle in communication with the vehicle gas leak detection sensor to identify a gas leak based on the detection of the presence and concentration of the gasses and a communication device carried by the vehicle and in communication with the controller and the plant subsystem. The communication device can be operable to transmit a vehicle alarm signal to the plant subsystem in response to the controller identifying the gas leak and to receive a plant alarm signal from the plant subsystem.
B. A method for operating a gas leak detection system can include (a) detecting the presence and concentration of a gas in the atmosphere with a gas leak detection sensor, (b) identifying a gas leak at with a controller based on the concentration of the gas detected, (c) communicating an alarm signal between a plant subsystem disposed at an industrial facility and a vehicle subsystem in response to identifying the gas leak, wherein the vehicle subsystem is mounted to a vehicle operable in and around the industrial facility and (d) activating a siren of the vehicle subsystem in response to identifying the gas leak.
C. A gas leak detection apparatus can include a vehicle gas leak detection sensors carried by a vehicle operable in and around an industrial facility, at least one the vehicle and operable to detect the presence and concentration of gasses in the atmosphere in and around the vehicle and a controller carried by the vehicle and in communication with the vehicle gas leak detection sensor to identify a gas leak based on the concentration of the gas detected. The gas leak detection apparatus can further include a wind sensor in communication with the controller and operable to detect a direction and a speed of the wind around the vehicle, and also can include a communication device carried by the vehicle and in communication with the controller. The communication device can be operable to transmit a vehicle alarm signal to a plant subsystem of the industrial facility in response to the controller identifying a gas leak and to receive a plant alarm signal from the plant subsystem.

Each of embodiments A, B, and C may have one or more of the following additional elements in any combination: Element 1: wherein the vehicle subsystem further includes a wind sensor in communication with the controller and operable to detect direction and speed of wind around the vehicle. Element 2: wherein controller is operable to determine a direction away from the gas leak based on the direction and the speed of the wind detected by the wind sensor. Element 3: wherein the vehicle subsystem further includes an on-board computer system having a heads-up display for displaying the direction away from the gas leak. Element 4: wherein the vehicle subsystem further includes a communication gateway in communication with the communication device, the communication gateway operable to encrypt and verify communications sent and received between the plant subsystem and at the vehicle subsystem. Element 5: wherein the vehicle subsystem further includes a siren and an alarm activation circuit operable to activate the siren when the communication gateway verifies a vehicle alarm signal, or when a plant alarm signal has been transmitted from a trusted party to the communication device. Element 6: wherein the alarm activation circuit comprises: a normally open remote detection relay operable to close in response to receiving the vehicle alarm signal or the plant alarm signal; a normally open blockchain rely operable to close in response to the communication gateway verifying the vehicle alarm signal or the plant alarm signal has been transmitted from a trusted party to the communication device; and an alarm relay operable to activate the siren in response to the closure of both the remote detection relay and the blockchain relay. Element 7: wherein the alarm activation circuit further comprises a normally open local detection relay operable to close in response to the controller identifying a gas leak based on the concentration of gasses detected by the at least one vehicle gas leak detection sensor, wherein the alarm relay is further operable to activate the siren in response to the closure of the local detection relay. Element 8: wherein the vehicle subsystem further comprises a shutdown circuit including a normally closed control relay operably coupled to or in communication with the controller and operable to open in response to the controller identifying a flammable gas leak and remain closed in response to the controller identifying a non-flammable gas leak, wherein the vehicle is disabled in response to opening the control relay. Element 9: wherein the shutdown circuit includes at least one of a starter relay or an ignition coil of the vehicle operably coupled to the control relay such that opening the control relay interrupts a current to the starter relay or the ignition coil to thereby disable the vehicle.

Element 10: further comprising: detecting a speed and direction of the wind around the vehicle with a wind sensor of the vehicle subsystem; and determining with the controller directions for reaching a safe location and avoiding the gas leak based on the speed and direction of the wind detected. Element 11: further comprising displaying the directions on a heads-up display of the vehicle. Element 12: further comprising verifying the alarm signal was transmitted by a trusted party with a communication gateway prior to activating the siren. Element 13: further comprising disabling the vehicle in response to determining that the gas leak comprises a flammable gas. Element 14: wherein disabling the vehicle includes disabling at least one of an ignition coil or a starter relay.

Element 15: further comprising a communication gateway in communication with the communication device and operable to encrypt and verify communications sent and received between the plant subsystem and the vehicle subsystem. Element 16: further comprising an alarm activation circuit operable to activate a siren in response to either:
identifying the gas leak based on detecting a gas with a local gas leak detection sensor carried by the vehicle; or verifying a received alarm signal was transmitted form a trusted party with the communication gateway. Element 17: further comprising a shutdown circuit operable to interrupt a current to either an ignition coil or a starter relay of the vehicle to disable the vehicle in response to identifying a flammable gas leak.

By way of non-limiting example, exemplary combinations applicable to A, B, and C include: Element 1 with Element 2; Element 2 with Element 3; Element 4 with Element 5; Element 5 with Element 6; Element 6 with Element 7; Element 8 with Element 9; Element 10 with Element 11, Element 12 with Element 13, Element 13 with Element 14 and Element 15 with Element 16.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A gas leak detection system, comprising:
a plant subsystem including a plant gas leak detection sensor disposed at a stationary location at an industrial facility and operable to detect the presence and concentration of gasses in the atmosphere in and around the industrial facility;
a vehicle operable in and around the industrial facility and including an ignition system; and
a vehicle subsystem mounted to the vehicle and including;
a vehicle gas leak detection sensor operable to detect a presence and a concentration of gasses in the atmosphere in and around the vehicle;
a siren;
a controller in communication with the vehicle gas leak detection sensor to identify a gas leak based on detection of the presence and the concentration of the gasses to activate the siren in response to identifying the gas leak and to transmit a signal to the ignition system to disable the vehicle in response to identifying a flammable gas leak; and
a communication device in communication with the controller and the plant subsystem, the communication device operable to transmit a vehicle alarm signal to the plant subsystem in response to the controller identifying the gas leak and to receive a plant alarm signal from the plant subsystem.

2. The system of claim 1, wherein the vehicle subsystem further includes a wind sensor in communication with the controller and operable to detect direction and speed of wind around the vehicle.

3. The system of claim 2, wherein controller is operable to determine a direction away from the gas leak based on the direction and the speed of the wind detected by the wind sensor.

4. The system of claim 3, wherein the vehicle subsystem further includes an on-board computer system having a heads-up display for displaying the direction away from the gas leak.

5. The system of claim 1, wherein the vehicle subsystem further includes a communication gateway in communication with the communication device, the communication gateway operable to encrypt and verify communications sent and received between the plant subsystem and the vehicle subsystem.

6. The system of claim 5, wherein the vehicle subsystem further includes a siren and an alarm activation circuit operable to activate the siren when the communication gateway verifies a vehicle alarm signal, or when a plant alarm signal has been transmitted from a trusted party to the communication device.

7. The system of claim 6, wherein the alarm activation circuit comprises:
a normally open remote detection relay operable to close in response to receiving the vehicle alarm signal or the plant alarm signal;
a normally open blockchain rely operable to close in response to the communication gateway verifying the vehicle alarm signal or the plant alarm signal has been transmitted from a trusted party to the communication device; and
an alarm relay operable to activate the siren in response to the closure of both the remote detection relay and the blockchain relay.

8. The system of claim 7, wherein the alarm activation circuit further comprises a normally open local detection relay operable to close in response to the controller identifying a gas leak based on the concentration of gasses detected by the at least one vehicle gas leak detection sensor, wherein the alarm relay is further operable to activate the siren in response to the closure of the local detection relay.

9. The system of claim 1, wherein the vehicle subsystem further comprises a shutdown circuit including a normally closed control relay in communication with the controller and operable to:
open in response to the controller identifying a flammable gas leak; and
remain closed in response to the controller identifying a non-flammable gas leak,
wherein the vehicle is disabled in response to opening the control relay.

10. The system of claim 9, wherein the shutdown circuit includes at least one of a starter relay or an ignition coil of the vehicle operably coupled to the control relay such that opening the control relay interrupts a current to the starter relay or the ignition coil to thereby disable the vehicle.

11. A method for operating a gas leak detection system, the method comprising:
detecting the presence and concentration of a gas in the atmosphere with a gas leak detection sensor;
identifying a gas leak with a controller based on the concentration of the gas detected;
communicating an alarm signal between a plant subsystem disposed at an industrial facility and a vehicle subsystem in response to identifying the gas leak, wherein the vehicle subsystem is mounted to a vehicle operable in and around the industrial facility;
activating a siren of the vehicle subsystem in response to identifying the gas leak; and
disabling the vehicle in response to determining that the gas leak comprises a flammable gas.

12. The method of claim 11, further comprising:
detecting a speed and direction of the wind around the vehicle with a wind sensor of the vehicle subsystem; and
determining with the controller directions for reaching a safe location and avoiding the gas leak based on the speed and direction of the wind detected.

13. The method of claim 12, further comprising displaying the directions on a heads-up display of the vehicle.

14. The method of claim 11, further comprising verifying the alarm signal was transmitted by a trusted party with a communication gateway prior to activating the siren.

15. (canceled)

16. The method of claim 11, wherein disabling the vehicle includes disabling at least one of an ignition coil or a starter relay.

17. A gas leak detection apparatus, comprising
a vehicle gas leak detection sensor carried by a vehicle operable in and around an industrial facility and operable to detect the presence and concentration of gasses in the atmosphere in and around the vehicle;
a controller carried by the vehicle and in communication with the vehicle gas leak detection sensor to identify a gas leak based on the concentration of the gas detected, to activate a siren in response to identifying the gas leak, and to transmit a signal to an ignition system of the vehicle to disable the vehicle in response to identifying a flammable gas leak;
a wind sensor in communication with the controller and operable to detect a direction and a speed of the wind around the vehicle; and
a communication device carried by the vehicle and in communication with the controller, the communication device operable to transmit a vehicle alarm signal to a plant subsystem of the industrial facility in response to the controller identifying a gas leak and to receive a plant alarm signal from the plant subsystem.

18. The apparatus of claim 17, further comprising a communication gateway in communication with the communication device and operable to encrypt and verify communications sent and received between the plant subsystem and the vehicle subsystem.

19. The apparatus of claim 18, further comprising an alarm activation circuit operable to activate a siren in response to either:
identifying the gas leak based on detecting a gas with a local gas leak detection sensor carried by the vehicle; or
verifying a received alarm signal was transmitted form a trusted party with the communication gateway.

20. The apparatus of claim 17, further comprising a shutdown circuit operable to interrupt a current to either an ignition coil or a starter relay of the vehicle to disable the vehicle in response to identifying a flammable gas leak.

21. The method of claim 11, further comprising operating the vehicle to close windows and unlock doors of the vehicle in response to determining that the gas leak comprises a flammable gas.
